(19) United States
(12) Patent Application Publication
(10) Pub. No.: US 2024/0186769 A1
(43) Pub. Date: Jun. 6, 2024

(54) METALLIC SHELL AND SPARK PLUG

(71) Applicant: Niterra Co., Ltd., Nagoya-shi, Aichi (JP)

(72) Inventors: Takahiro SANDA, Nagoya-shi, Aichi (JP); Keita SUGIHARA, Nagoya-shi, Aichi (JP); Noriyasu HASEGAWA, Nagoya-shi, Aichi (JP); Yohei KOZAKAI, Nagoya-shi, Aichi (JP)

(73) Assignee: Niterra Co., Ltd., Nagoya-shi, Aichi (JP)

(21) Appl. No.: 18/285,611

(22) PCT Filed: Jul. 14, 2022
(86) PCT No.: PCT/JP2022/027678

§ 371 Date: Oct. 4, 2023

(30) Foreign Application Priority Data
Aug. 18, 2021 (JP) 2021-133385

(51) Int. Cl. H01T 13/36

(52) U.S. Cl. CPC H01T 13/36

(57) ABSTRACT

A spark plug includes a metallic shell. The metallic shell includes a tubular metallic shell body, a zinc plating layer provided on a surface of the metallic shell body and containing zinc as a main component, a chromium layer provided to cover the zinc plating layer and containing chromium as a main component, and a silicon layer provided to cover the chromium layer and containing silicon as a main component.

### TECHNICAL FIELD

The present disclosure relates to a metallic shell used in a spark plug used for an internal combustion engine, and to a spark plug including this metallic shell.

### BACKGROUND OF THE INVENTION

Spark plugs have been used as igniting means of internal combustion engines such as engines for automobiles. Such a spark plug includes a rod-shaped center electrode, an insulator which holds the center electrode on its a forward end side and extends in an axial direction, and a tubular metallic shell which holds the insulator therein. The spark plug is configured such that spark discharge occurs between a forward end portion of the center electrode and a ground electrode attached to a forward end portion of the metallic shell.

In general, the metallic shell is formed of an iron-based material such as carbon steel, and its surface is plated for corrosion prevention. Such plating is performed, for example, in an alkaline plating bath containing zinc. As a result, a zinc plating layer is formed on the surface of the metallic shell. The zinc plating layer has an excellent corrosion prevention effect for iron. However, the zinc plating layer formed on the surface of a metallic shell formed of iron has drawbacks in that the zinc plating layer is easily consumed due to sacrificial corrosion, and tends to whiten due to produced zinc oxide, thereby impairing the appearance of the metallic shell.

In view of the above, in many spark plugs, the surface of the zinc plating layer is further covered with chromate conversion coating so as to prevent corrosion of the plating layer. For example, Patent Literature 1 discloses a spark plug in which the surface of its metallic shell is covered with silicon-containing chromate conversion coating whose cationic components mainly include chromium and silicon and in which 90 wt. % or more of chromium is trivalent chromium.

### CITATION LIST

### Patent Literature

Patent Literature 1: JP2000-48930A

### Technical Problem

Although a spark plug covered with such chromate conversion coating can suppress corrosion of the zinc plating layer, such a spark plug has raised a problem in that some components contained in the chromate conversion coating are eluted into the environment in the form of hexavalent chromium.

Elusion of hexavalent chromium from the coating on the surface of the metallic shell may be accelerated by the cobalt component contained in the coating. Therefore, it is possible to suppress elution of hexavalent chromium by lowering the cobalt content of the coating. However, since cobalt contained in the coating has an action of suppressing corrosion of the surface of the metallic shell, excessive lowering of the cobalt content may result in easier occurrence of corrosion.

In view of the above, an object in a first aspect of the present disclosure is to provide a metallic shell for a spark plug which has enhanced corrosion resistance while suppressing elution of hexavalent chromium and a spark plug including this metallic shell.

### SUMMARY OF INVENTION

### Solution to Problem

A metallic shell according to the first aspect of the present disclosure is a metallic shell for a spark plug and includes a tubular metallic shell body: a zinc plating layer provided on a surface of the metallic shell body and containing zinc as a main component: a chromium layer provided to cover the zinc plating layer and containing chromium as a main component; and a silicon layer provided to cover the chromium layer and containing silicon as a main component. In this metallic shell, the ratio of a thickness of the silicon layer to a thickness of the chromium layer is 0.8 or greater, and the cobalt content of the chromium layer is 0.1 mass % or less.

The above-described configuration yields the following effects. Since the cobalt content of the chromium layer is 0.1 mass % or less, elution of hexavalent chromium from the metallic shell can be suppressed. Since the silicon layer is provided to cover the chromium layer, the corrosion prevention performance of the coating provided on the surface of the metallic shell can be enhanced. Since the thickness of the silicon layer is defined as described above, even when the cobalt content of the chromium layer is reduced, a coating having a sufficient corrosion prevention performance can be obtained. Accordingly, by virtue of the above-described configuration, a metallic shell which suppresses elution of hexavalent chromium and which has enhanced corrosion resistance can be obtained.

In the above-described metallic shell according to the first aspect of the present disclosure, the thickness of the chromium layer may be less than 20 μm.

By virtue of the above-described configuration, the absolute amount of chromium contained in the surface coating of the metallic shell can be reduced by reducing the thickness of the chromium layer to be less than 20 μm. As a result, elution of hexavalent chromium from the metallic shell can be suppressed further.

In the above-described metallic shell according to the first aspect of the present disclosure, the ratio of the thickness of the silicon layer to the thickness of the chromium layer may be 1.9 or greater.

The above-described configuration can further enhance the corrosion resistance of the metallic shell.

A spark plug according to a second aspect of the present disclosure comprises the above-described metallic shell according to the first aspect of the present disclosure; a tubular insulator at least partially disposed in the metallic shell; a center electrode disposed at a forward end of the insulator; and a ground electrode joined to the metallic shell and forming a gap between the ground electrode and the center electrode.

By virtue of the above-described configuration, it is possible to obtain a spark plug including a metallic shell which suppresses elution of hexavalent chromium and which has enhanced corrosion resistance. Accordingly, the corrosion resistance of the spark plug can be enhanced, and an adverse effect on the environment; i.e., elution of hexavalent chromium, can be reduced.

### Advantageous Effects of Invention

As described above, according to the first aspect of the present disclosure, there can be obtained a spark plug metallic shell which has enhanced corrosion resistance while suppressing elution of hexavalent chromium. Also, according to the second aspect of the present disclosure, there can be obtained a spark plug which can suppress elution of hexavalent chromium and has enhanced corrosion resistance.

### BRIEF DESCRIPTION OF DRAWINGS

FIG. 1 is a partial sectional view showing the appearance and internal structure of a spark plug according to one embodiment.

FIG. 2 is a schematic sectional view showing the configuration of a part of a surface portion of a metallic shell of the spark plug shown in FIG. 1.

FIG. 3 is a flowchart showing a portion of a process of manufacturing the spark plug shown in FIG. 1. Specifically, a flowchart showing steps of forming a coating on the metallic shell.

FIG. 4 is a schematic view showing a state in which a Cr layer plus Si layer forming step shown in FIG. 3 is performed.

FIG. 5 is a graph showing the results of a corrosion resistance test 2 in the present example.

FIG. 6 is a graph showing the results of a chromium elution test in the present example.

### DETAILED DESCRIPTION OF THE INVENTION

An embodiment of the present invention will now be described with reference to the drawings. In the following description, identical components are denoted by the same reference sign. Their names and functions are the same. Therefore, detailed description of the identical components will not be repeated.

In the present embodiment, a spark plug 1 will be described as an example. Also, in the present embodiment, a method for manufacturing a metallic shell 30 which constitutes the spark plug 1 will be described.

### Structure of Spark Plug

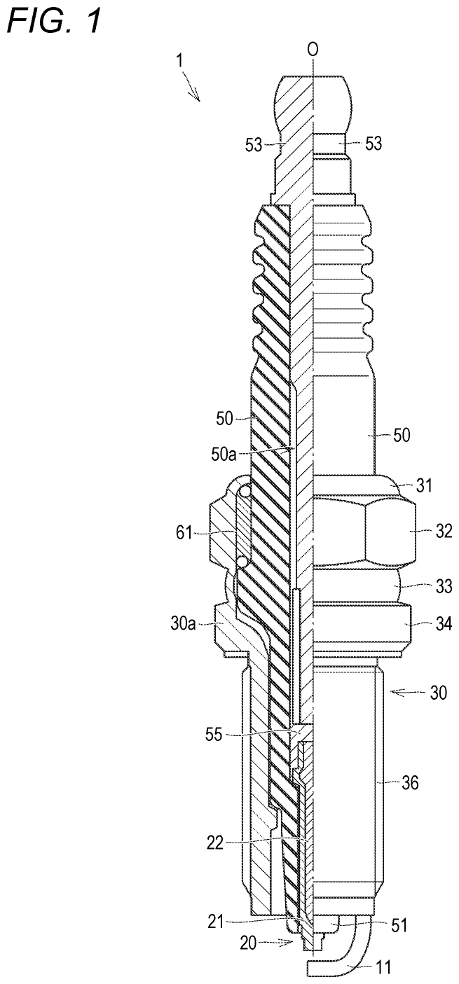

First, the overall structure of the spark plug 1 will be described with reference to FIG. 1. The spark plug 1 includes an insulator 50 and the metallic shell 30.

The insulator 50 is an approximately cylindrical tubular member extending in a longitudinal direction of the spark plug 1. An axial hole 50a extending along an axial line O is formed in the insulator 50. The insulator 50 is formed of a material which is excellent in insulating property, heat resistance, and heat conductivity. For example, the insulator 50 is formed of an alumina-based ceramic material or the like.

A center electrode 20 is provided in a forward end portion 51 of the insulator 50. In the present embodiment, a side in the spark plug 1 where the center electrode 20 is provided will be referred to as the forward end side of the spark plug 1, and a side opposite the forward end side will be referred to as the rear end side. In FIG. 1, the lower side is the forward end side, and the upper side is the rear end side.

A metallic terminal member 53 is attached to the other end (namely, a rear end portion) of the insulator 50. An electrically conductive glass seal 55 is provided between the center electrode 20 and the metallic terminal member 53.

The center electrode 20 is inserted into and held in the axial hole 50a of the insulator 50 in such a manner that a forward end portion of the center electrode 20 protrudes from the forward end portion 51 of the insulator 50. The center electrode 20 has an electrode base member 21 and a core 22. The electrode base member 21 is formed of, for example, a metallic material such as an Ni-based alloy containing Ni (nickel) as a main component. An example of an alloy element added to the Ni-based alloy is Al (aluminum). The core 22 is embedded in the electrode base member 21. The core 22 may be formed of a metallic material (for example, Cu (copper) or Cu alloy or the like) which is more excellent in thermal conductivity than the electrode base member 21. The electrode base member 21 and the core 22 are united together by means of forging. Notably, this configuration is one example, and the core 22 may be omitted. Namely, the center electrode 20 may be formed of the electrode base member only.

The metallic shell 30 is an approximately cylindrical tubular member which is fixed to a threaded hole of an internal combustion engine. The metallic shell 30 is provided to partially cover the insulator 50. In a state in which a portion of the insulator 50 has been inserted into the metallic shell 30 having an approximately cylindrical tubular shape, a gap present between the metallic shell 30 and the insulator 50 on the rear end side of the metallic shell 30 is filled with talc 61.

The main body portion of the metallic shell 30 is formed of a tubular metallic shell body 30a. The metallic shell body 30a is formed of a metallic material having electrical conductivity. Examples of such a metallic material include low carbon steel and a metallic material which contains iron as a main component. The metallic shell body 30a has mainly a crimp portion 31, a tool engagement portion 32, a curved portion 33, a bearing portion 34, a trunk portion 36, etc., which are disposed in this order from the rear end side.

The tool engagement portion 32 is a portion with which a tool such as a wrench is engaged when the metallic shell 30 is attached to the threaded hole of the internal combustion engine. The crimp portion 31 is formed on the rear end side of the tool engagement portion 32. The crimp portion 31 is bent radially inward such that the degree of bending increases toward the rear end side. The bearing portion 34 is located between the tool engagement portion 32 and the trunk portion 36, and an annular gasket is disposed on the forward end side. In a state in which the spark plug 1 is attached to the internal combustion engine, the bearing portion 34 presses the annular gasket against an unillustrated engine head. The curved portion 33 having a small wall thickness is formed between the tool engagement portion 32 and the bearing portion 34. The trunk portion 36 is located on the side where the forward end portion 51 of the insulator 50 is present. When the spark plug 1 is attached to the internal combustion engine, a screw groove (not show) formed on the outer circumference of the trunk portion 36 is screwed into the threaded hole of the internal combustion engine.

Also, a ground electrode 11 is provided on the forward end portion side of the metallic shell 30 (on the side where the trunk portion 36 is located). The ground electrode 11 is joined to the metallic shell 30 by means of, for example, welding. The ground electrode 11 is a plate-like member bent to have an approximately L-like shape as a whole, and a proximal end portion of the ground electrode 11 is fixedly joined to a forward end surface of the metallic shell 30. A distal end portion of the ground electrode 11 extends to a position through which an imaginary extension line of the axial line O of the insulator 50 passes. A noble metal tip (not shown) which faces a forward end surface of the center electrode 20 is welded to a surface of the ground electrode 11, which surface is located on the side toward the center electrode 20, such that the noble metal tip is located near the distal end of the ground electrode 11.

As a result, the distal end of the ground electrode 11 is disposed to face the forward end portion of the center electrode 20, and a gap in which spark discharge occurs is formed between the distal end of the ground electrode 11 (specifically, the noble metal tip welded to the ground electrode 11) and the forward end portion of the center electrode 20.

The ground electrode 11 is formed, for example, by using, as an electrode base material, a metallic material such as an Ni-based alloy containing Ni (nickel) as a main component. An example of an alloy element added to the Ni-based alloy is Al (aluminum). The ground electrode 11 may contain, as a component other than Ni, at least one element selected from Mn (manganese), Cr (chromium), Al (aluminum), and Ti (titanium).

### Structure of Metallic Shell

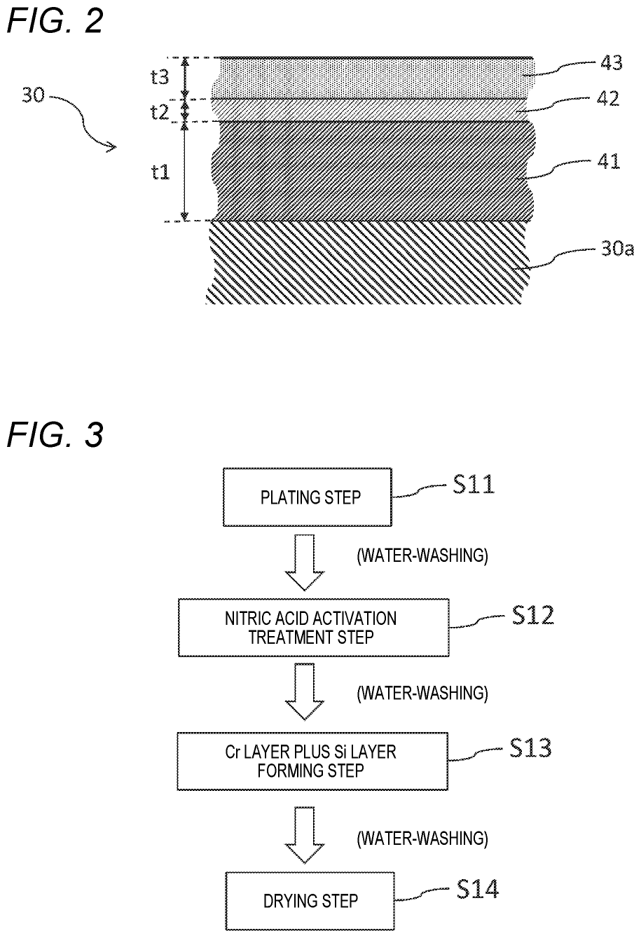

Subsequently, the structure of the metallic shell 30, which constitutes the spark plug 1, will be described more specifically. Here, a coating formed on the surface of the metallic shell 30 will be described. FIG. 2 shows a sectional structure of a part of a surface portion of the metallic shell 30.

The coating on the surface of the metallic shell 30 is composed of a plurality of layers containing different types of components. This coating has at least three layers: i.e., a zinc plating layer 41, a chromium layer 42, and a silicon layer 43. Specifically, the coating on the surface of the metallic shell 30 has a structure in which the zinc plating layer 41, the chromium layer 42, and the silicon layer 43 are stacked in this order from the side near the metallic shell body 30a (see FIG. 2).

The zinc plating layer 41 is provided on the surface of the metallic shell body 30a. The chromium layer 42 is provided to cover the zinc plating layer 41. The silicon layer 43 is provided to cover the chromium layer 42.

The zinc plating layer 41 contains zinc (Zn) as a main component. The expression “contains Zn as a main component” means that, among the elements contained in the zinc plating layer 41, Zn is contained in the largest amount. The zinc plating layer 41 can be formed by performing a conventionally known galvanizing process on the surface of the metallic shell body 30a. The thickness t1 of the zinc plating layer 41 may be set to fall within the range of, for example, 3 μm to 10 μm.

The chromium layer 42 contains chromium (Cr) as a main component. The expression “contains Cr as a main component” means that, among the elements contained in the chromium layer 42, Cr is contained in the largest amount. The Cr component of the chromium layer 42 is mostly (for example, 90 mass % or more of the entire Cr component) present as a trivalent chromium chromate.

The chromium layer 42 may contain additional elements other than chromium, such as cobalt (Co), zinc (Zn), and iron (Fe). Notably, in the case where the chromium layer 42 contains cobalt, the cobalt content of the chromium layer 42 is 0.1 mass % or less.

Cr in the trivalent chromium-based chromate is present in the form of Cr³⁺ at the time of coating formation. If Co is contained in the coating, Cr³⁺ is oxidized by this Co component, and changes to Cr⁶⁺ (hexavalent chromium) with time. Therefore, setting the cobalt content of the chromium layer 42 to 0.1 mass % or less allows the Cr component in the coating to exist stably in the form of Cr³⁺. As a result, the amount of elution of hexavalent chromium from the coating can be reduced. Notably, it is preferred that the chromium layer 42 contain no cobalt from the viewpoint of further reducing the amount of elution of hexavalent chromium from the coating.

The chromium layer 42 can be formed by performing a coating process which will be described later on the metallic shell body 30a with the zinc plating layer 41 formed thereon. The thickness t2 of the chromium layer 42 may be set to fall within the range of, for example, 0.05 μm to 0.30 μm. Setting the thickness t2 of the chromium layer 42 to 0.05 μm or greater facilitates formation of the silicon layer 43, which is the uppermost layer. As a result, the corrosion prevention effect of the zinc plating layer 41 covered with the silicon layer 43 and the chromium layer 42 can be enhanced. Also, setting the thickness t2 of the chromium layer 42 to 0.30 μm or less reduces the amount of chromium to be used.

Also, the thickness of the chromium layer 42 is preferably less than 0.20 μm. By reducing the thickness of the chromium layer 42 to be less than 0.20 μm, the absolute amount of chromium contained in the coating on the surface of the metallic shell can be reduced. As a result, elution of hexavalent chromium from the metallic shell can be suppressed further.

The silicon layer 43 contains silicon (Si) as a main component. The expression “contains Si as a main component” means that, among the elements contained in the silicon layer 43, Si is contained in the largest amount. The greater part of the Si component of the silicon layer 43 is present in the form of silicon oxides (for example, silica).

The silicon layer 43 can be formed by performing a coating process which will be described later on the metallic shell body 30a with the zinc plating layer 41 formed thereon. The thickness t3 of the silicon layer 43 may be set to fall within the range of, for example, 0.05 μm to 1.0 μm. Setting the thickness t3 of the silicon layer 43 to 0.05 μm or greater enhances the corrosion prevention effect of the zinc plating layer 41. Also, setting the thickness t3 of the silicon layer 43 to 1.0 μm or less prevents the degree of insulation of the surface of the metallic shell 30 from increasing, thereby maintaining the electricity conducting performance of the spark plug 1.

The ratio t3/t2 of the thickness t3 of the silicon layer 43 to the thickness t2 of the chromium layer 42 is 0.8 or greater. Since the ratio between the thicknesses of these layers is set in this manner, even when the cobalt content of the chromium layer 42 is reduced, corrosion of the surface of the metallic shell can be suppressed.

Notably, the ratio t3/t2 of the thickness t3 of the silicon layer 43 to the thickness t2 of the chromium layer 42 is more preferably 1.9 or greater. By setting the ratio between the thicknesses of these layers in this manner, the effect of preventing corrosion of the surface of the metallic shell can be enhanced further.

Although no particular limitation is imposed on the upper limit of the ratio t3/t2 of the thickness t3 of the silicon layer 43 to the thickness t2 of the chromium layer 42, the ratio t3/t2 is preferably set to, for example, 20 or less in consideration of the ordinary range of the thickness t2 of the chromium layer 42 and the ordinary range of the thickness t3 of the silicon layer 43.

Notably, in a different embodiment, the coating on the surface of the metallic shell 30 may further contain an additional layer in addition to the zinc plating layer 41, the chromium layer 42, and the silicon layer 43. For example, an intermediate layer mainly containing zinc (Zn) and chromium (Cr) may be provided between the zinc plating layer 41 and the chromium layer 42. Also, an intermediate layer mainly containing chromium (Cr) and silicon (Si) may be provided between the chromium layer 42 and the silicon layer 43.

### Metallic Shell Manufacturing Method

Subsequently, a method for manufacturing the metallic shell 30 will be described. First, the metallic shell body 30a is manufactured. Since a conventionally known manufacturing method can be applied to manufacture of the metallic shell body 30a, detailed description of a method for manufacturing the metallic shell body 30a is omitted.

Subsequently, a coating (specifically, the zinc plating layer 41, the chromium layer 42, the silicon layer 43, etc.) is formed on the surface of the metallic shell body 30a. FIG. 3 shows steps of forming the coating on the surface of the metallic shell body 30a. As shown in FIG. 3, the steps of forming the coating mainly include a plating step (S11), a nitric acid activation treatment step (S12), a Cr layer plus Si layer forming step (S13), and a drying step (S14). Also, a water-washing step of washing the metallic shell body 30a is performed between the above-described steps.

In the plating step (S11), the zinc plating layer 41 is formed on the surface of the metallic shell body 30a by using, for example, a conventionally known electro-galvanizing method. Subsequently, the nitric acid activation treatment step (S12) is performed. In this step, the metallic shell body 30a is immersed into an acidic solution containing nitric acid, thereby removing alkaline substances from the surface of the zinc plating layer 41.

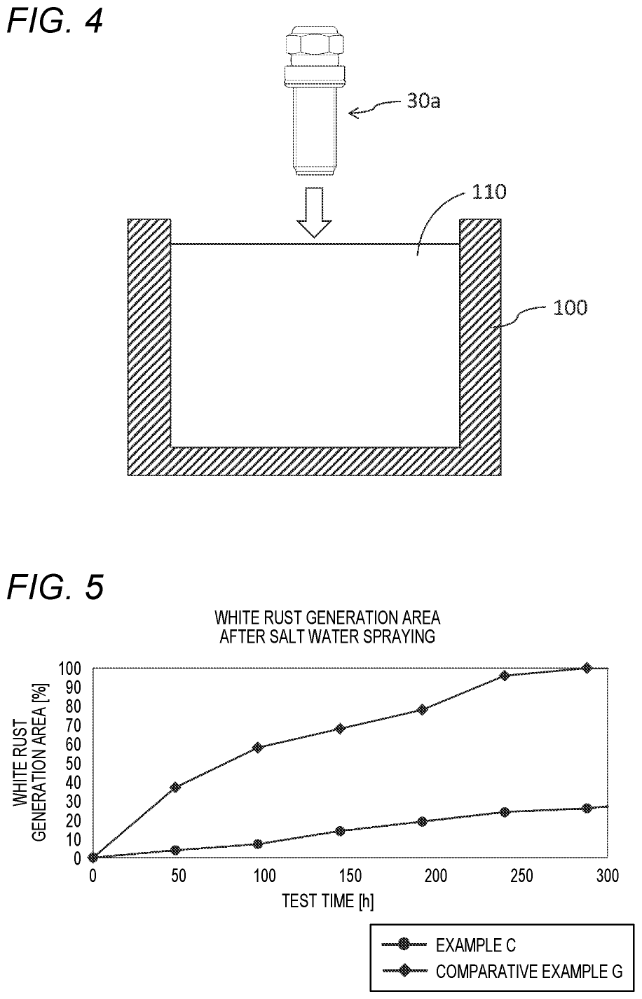

After completion of the nitric acid activation treatment step (S12), the Cr layer plus Si layer forming step (S13) is performed. Specifically, as shown in FIG. 4, the metallic shell body 30a having undergone plating is immersed into a chemical tank 100 filled with a chromate treatment solution 110.

The chromate treatment solution 110 mainly contains a chromium supply agent, a silicon supply agent, and an additive. The chromium supply agent contains chromium nitrate, a carboxylate salt, etc. The silicon supply agent contains SiO₂, etc. The additive includes, for example, a metal chloride.

Notably, the chromate treatment solution 110 preferably contains cobalt in a very small amount (for example, 0.1 mass % or less) or contains no cobalt. Thus, the cobalt content of the chromium layer 42 can be made 0.1 mass % or less.

The pH of the chromate treatment solution 110 may be set to fall within the range of, for example, 2 to 3. The pH can be adjusted by adding nitric acid or hydrochloric acid and sodium hydrate. The temperature of the chromate treatment solution 110 may be set to fall within the range of, for example, 20° C. to 40° C. The time (treatment time) during which the metallic shell body 30a is immersed in the chromate treatment solution 110 may be set to fall within the range of, for example, 30 sec. to 60 sec.

As a result of performance of the Cr layer plus Si layer forming step (S13) under the above-described conditions, the chromium layer 42 and the silicon layer 43 are successively formed on the surface of the metallic shell body 30a with the zinc plating layer 41 formed thereon. The thickness t2 of the chromium layer 42 and the thickness t3 of the silicon layer 43 can be adjusted by appropriately changing the above-described conditions (namely, the formulation, pH, and temperature of the chromate treatment solution 110 and the immersion time).

After completion of the Cr layer plus Si layer forming step (S13), the metallic shell body 30a is removed from the chromate treatment solution 110, and the drying step (S14) is performed so as to dry the coating formed on the surface of the metallic shell body 30a. In the drying step (S14), the environmental temperature is preferably set to 40 to 220° C.

The coating is formed on the surface of the metallic shell body 30a as described above. After that, the ground electrode 11, etc. are attached to the forward end side of the metallic shell body 30a. Thus, the metallic shell 30 is obtained. This metallic shell 30 is used as one of the parts of the spark plug 1 at the time of manufacture thereof. Since a conventionally known manufacturing method can be applied to manufacture of the spark plug 1 including the metallic shell 30, its detailed description is omitted.

### Summary of Embodiment

As described above, the spark plug 1 according to the present embodiment includes the metallic shell 30, the insulator 50, the center electrode 20, and the ground electrode 11. The metallic shell 30 includes the tubular metallic shell body 30a, the zinc plating layer 41 provided on the surface of the metallic shell body 30a and containing zinc as a main component, the chromium layer 42 provided to cover the zinc plating layer 41 and containing chromium as a main component, and the silicon layer 43 provided to cover the chromium layer 42 and containing silicon as a main component.

In this metallic shell 30, the ratio of the thickness t3 of the silicon layer 43 to the thickness t2 of the chromium layer 42 is 0.8 or greater, and the cobalt content of the chromium layer 42 is 0.1 mass % or less.

The cobalt component of the chromium layer 42 may cause elution of hexavalent chromium from the metallic shell. In view of this, in the spark plug 1 according to the present embodiment, the cobalt content of the chromium layer 42 is set to 0.1 mass % or less in order to suppress formation of hexavalent chromium in the coating on the surface of the metallic shell 30. However, since cobalt suppresses corrosion of the surface of the metallic shell, excessively reducing the cobalt content may promote corrosion.

In view of the above, in the present embodiment, the silicon layer 43 is formed to cover the chromium layer 42 provided on the surface of the metallic shell 30, and the ratio of the thickness t3 of the silicon layer 43 to the thickness t2 of the chromium layer 42 is a predetermined ratio or greater (namely, t3/t2≥0.8).

Since the silicon layer 43 is provided to cover the chromium layer 42, the corrosion prevention performance of the coating provided on the surface of the metallic shell 30 can be enhanced. As a result, corrosion of the metallic shell body 30a can be suppressed more reliably.

Also, since the thickness t3 of the silicon layer 43 is defined as described above, even when the cobalt content of the chromium layer 42 is reduced, a coating having a sufficient corrosion prevention performance can be obtained. Also, the effect of protecting the zinc plating layer 41 is enhanced, whereby sacrificial corrosion of the zinc plating layer 41 can be suppressed.

Accordingly, the present embodiment can provide the metallic shell 30 which suppresses elution of hexavalent chromium and has enhanced corrosion resistance. Accordingly, the spark plug 1 which has enhanced corrosion resistance and a reduced adverse effect on the environment can be obtained.

### Example

One example will now be described. Notably, the present invention is not limited to the following example.

### Formation of Coating on Metallic Shell Body

In the present example, a plurality of metal bodies 30a having the structure described in the above-described embodiment were prepared and a treatment for forming a coating on the surface was performed. Notably, although no particular limitation is imposed on the material of the metallic shell body 30a, a low carbon steel was used in the present example.

First, each metallic shell body 30a was plated. Specifically, a zinc plating layer 41 having a thickness of about 0.5 to 1.0 μm was formed by performing a conventionally known electro-galvanizing process using an alkaline bath.

Subsequently, after performing water-washing and nitric acid activation by ordinary methods, the metallic shell body 30a was immersed in the chromate treatment solution 110 for chromate treatment (namely, the Cr layer plus Si layer forming step in the present embodiment). As a result, the chromium layer 42 and the silicon layer 43 were formed on the surface of the zinc plating layer 41.

The chromate treatment solution 110 used contained the following agents, solvent, etc. Notably, the proportions of the respective agents were modified among samples

### Examples A to D and Comparative Examples E to G

A chromium (Cr) supply agent content (as Cr content) of treatment solution: 1000 to 2000 ppm.

A silicon (Si) supply agent content (as Si content) of treatment solution: 900 to 5500 ppm.

Additive content of treatment solution: 0.1 to 5 mL/L.

The Cr layer plus Si layer forming step was performed for a plurality of samples of the metallic shell body 30a under different conditions. Table 1 shows the conditions of the chromate treatment applied to the samples (Examples A to D and Comparative Examples E to G) (the mixing proportions of the agents contained in the treatment solution, the temperature of the treatment solution, and the pH of the treatment solution). The treatment time (immersion time) applied to the samples (Examples A to D and Comparative Examples E to G) was 45 sec.

Notably, in Table 1, as to the concentrations of the Cr supply agent, the Si supply agent, and the additive contained in the chromate treatment solution 110, each of the concentrations employed in Examples and Comparative Examples is represented by a numerical value “1” to “5” which represents one of 5 concentration ranges obtained by dividing the above-described concentration range. Specifically, as to the Cr supply agent, a numerical value “3” represents about 1500 ppm, and a numerical value “4” represents about 1750 ppm. As to the Si supply agent, a numerical value “1” represents about 900 ppm, a numerical value “2” represents about 2050 ppm, a numerical value “3” represents about 3200 ppm, and a numerical value “4” represents about 4350 ppm. As to the additives, a numerical value “2” represents about 1.25 mL/L, a numerical value “3” represents about 2.5 mL/L, and a numerical value “4” represents about 3.75 mL/L. In Comparative Example G, a chromate treatment was performed by using a treatment solution in which the concentration of the Cr supply agent was 90 mL/L and which did not contain the Si supply agent and the additives.

TABLE 1

| | | | | | | Comp. | Comp. | Comp. |
|---|---|---|---|---|---|---|---|---|
| | | Ex. A | Ex. B | Ex. C | Ex. D | Ex. E | Ex. F | Ex. G |
| Sample | Cr supply agent | 3 | 3 | 3 | 4 | 3 | 3 | 90 mL/L |
| preparation | Si supply agent | 1 | 2 | 3 | 4 | — | 1 | — |
| conditions | Additive | 3 | 2 | 3 | 4 | 3 | 2 | — |
| | Temperature | 25° C. | 25° C. | 30° C. | 35° C. | 30° C. | 25° C. | 30° C. |
| | pH | 2.50 | 2.50 | 2.50 | 2.25 | 2.50 | 3.00 | 2.0 |

### Measurement of Thicknesses of Layers

Each of the samples of the metallic shell body 30a (Examples A to D and Comparative Examples E to G) was coated as described above. Subsequently, the thicknesses t2 and t3 of the chromium layer 42 and the silicon layer 43 formed on each sample were measured. This layer thickness measurement was performed by preparing a specimen by using a focused ion beam (FIB) system and observing the specimen under a scanning transmission electron microscope (STEM).

The measured thicknesses of each sample are shown in Table 2 provided below. Table 2 also shows the sum total (t2+t3) of the thicknesses of the layers, and the ratio (t3/t2) between the thicknesses of the layers.

Also, Table 2 shows the Cr and Si contents (mass %) of the coating of each sample. These contents were calculated through energy dispersive X-ray spectroscopy (EDX). The EDX system used was a product of Nippon Electric Datum (model No: JSM-6490LA).

TABLE 2

| | | | | | | Comp. | Comp. | Comp. |
|---|---|---|---|---|---|---|---|---|
| | | Ex. A | Ex. B | Ex. C | Ex. D | Ex. E | Ex. F | Ex. G |
| Thickness [μm] | Cr layer | 0.090 | 0.059 | 0.084 | 0.102 | 0.244 | 0.112 | 0.283 |
| | Si layer | 0.077 | 0.113 | 0.327 | 0.531 | 0 | 0.035 | — |
| | Cr layer + Si layer | 0.167 | 0.172 | 0.411 | 0.633 | 0.244 | 0.147 | — |
| | Cr layer/Si layer ratio | 0.854 | 1.920 | 3.915 | 5.184 | — | 0.317 | — |
| Content [wt %] | Cr | 0.80 | 0.48 | 0.73 | 0.94 | 2.20 | 1.00 | 1.39 |
| (EDX) | Si | 1.30 | 1.83 | 5.72 | 8.89 | 0.00 | 0.60 | — |

| | | | | | | | |
|---|---|---|---|---|---|---|---|
| Corrosion resistance evaluation | B | A | A | A | X | C | X |

Notably, the Co content (mass %) of the coating of each sample was calculated through energy dispersive X-ray spectroscopy (EDX) as in the case of the Cr and Si contents. The results show that each of the Co contents (mass %) of the coatings of the samples (Examples A to D and Comparative Examples E to G) was 0.1 mass % or less.

### Corrosion Resistance Test 1

A corrosion resistance test was conducted for the samples (Examples A to D and Comparative Examples E and F) with coatings formed thereon. Specifically, neutral salt water was sprayed to the samples for 96 hours in a neutral salt spray test based on JIS H8502. Subsequently, the states of the obtained samples were judged on the basis of the following
A: White rust generation area: 10% or less
B: White rust generation area: less than 20%
C: White rust generation area: not less than 20% and not greater than 50%
X: Red rust erosion into the base member (the metallic shell body 30a)

Table 2 shows the results of the above-described corrosion resistance test 1. As shown in Table 2, the results show that, in the samples in which the ratio (t3/t2) between the thicknesses of the layers is 0.8 or greater (namely, the samples of Examples A to D), corrosion does not occur in the zinc plating layer 41, the degree of generation of white rust on the surface is smaller (specifically, the white rust generation area is less than 20%), and corrosion resistance is good. Also, it was confirmed that, in the samples in which the ratio (t3/t2) between the thicknesses of the layers is 1.9 or greater (namely, the samples of Examples B to D), the degree of generation of white rust on the surface is smaller (specifically, the white rust generation area is less than 10%), and further enhanced corrosion resistance is attained.

### Corrosion Resistance Test 2

Another corrosion resistance test was performed for the sample of Example C shown in the above-described Table 1. Specifically, the neutral salt spray test based on JIS H8502 was carried out. Subsequently, the ratio between the area of white rust (corrosion area) generated on the tested sample to the area of the entire surface was measured. Also, for comparison, the same corrosion resistance test was performed for the sample of Comparative Example G.

FIG. 5 shows the results of the corrosion resistance test 2. As shown in FIG. 5, it was found that, in the sample of Example C, the ratio of generation of white rust was suppressed to 30% or less until elapse of 300 hours. In contrast, it was found that, in the sample of Comparative Example G, white rust was generated over almost the entirety of the surface of the sample before elapse of 300 hours.

### Chromium Elution Test

A test for determining whether or not elution of hexavalent chromium occurred was performed for the sample of Example D shown in the above-described Table 1. Specifically, the sample was left for 6 days in an environment (40° C. and humidity of 98%), and a hexavalent chromium elution test based on the European standard EN15205 was performed for the sample. For comparison, the same hexavalent chromium elution test was performed for the sample of Comparative Example G.

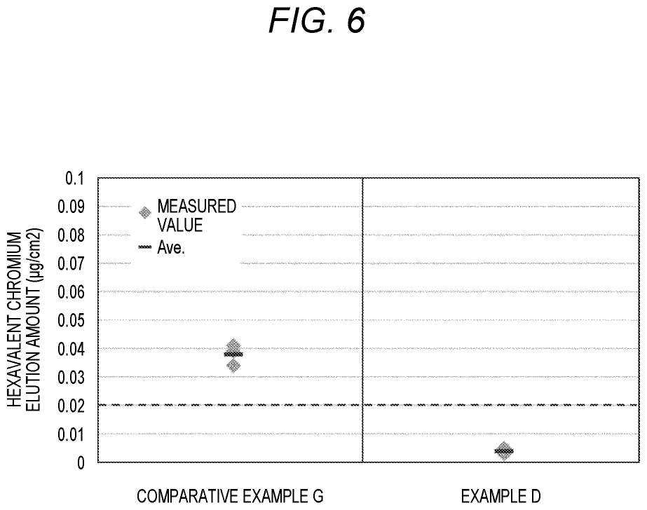

FIG. 6 shows the results of the chromium elution test. FIG. 6 shows not only the actually measured elution amounts of a plurality of samples of Example D and the actually measured elution amounts of a plurality of samples of Comparative Example G, but also the average (Ave.) of the measured elution amounts of the plurality of samples of Example D and the average (Ave.) of the measured elution amounts of the plurality of samples of Comparative Example G. As shown in FIG. 6, it was found that, in the samples of Example D, the elution amount of hexavalent chromium was 0.02 μg/cm² or less (namely, a detectable amount or less). In contrast, it was found that, in the samples of Comparative Example G, the elution amount of hexavalent chromium was about 0.03 to 0.04 μg/cm².

The above results reveal that the samples in which the thickness of the chromium layer 42 contained in the surface coating is less than 20 μm can suppress elution of hexavalent chromium from the metallic shell to a detectable level or less.

The embodiments disclosed this time must be considered to be illustrative and not restrictive in all aspects. It is intended that the scope of the present invention is shown by the claims rather than the above description, and the present invention encompasses all modifications within the meanings and scopes equivalent to those of the claims. Also, the present invention encompasses configurations obtained by combining the configurations of different embodiments described in the present specification.

### REFERENCE SIGNS LIST

1: spark plug
11: ground electrode
20: center electrode
30: metallic shell
30a: metallic shell body
41: zinc plating layer
42: chromium layer
43: silicon layer
50: insulator
t1: thickness of the zinc plating layer
t2: thickness of the chromium layer
t3: thickness of the silicon layer

1. A metallic shell for a spark plug comprising:
a tubular metallic shell body;
a zinc plating layer provided on a surface of the metallic shell body and containing zinc as a main component;
a chromium layer provided to cover the zinc plating layer and containing chromium as a main component; and
a silicon layer provided to cover the chromium layer and containing silicon as a main component, wherein
the ratio of a thickness of the silicon layer to a thickness of the chromium layer is 0.8 or greater, and
the cobalt content of the chromium layer is 0.1 mass % or less.

2. A metallic shell according to claim 1, wherein the thickness of the chromium layer is less than 20 μm.

3. A metallic shell according to claim 1, wherein the ratio of the thickness of the silicon layer to the thickness of the chromium layer is 1.9 or greater.

4. A spark plug comprising:
the metallic shell according to claim 1;
a tubular insulator at least partially disposed in the metallic shell;
a center electrode disposed at a forward end of the insulator; and
a ground electrode joined to the metallic shell and forming a gap between the ground electrode and the center electrode.
